(19) United States
(12) Patent Application Publication
(10) Pub. No.: US 2009/0012816 A1
(43) Pub. Date: Jan. 8, 2009

(54) SYSTEMS AND METHODS FOR CLINICAL ANALYSIS INTEGRATION SERVICES

(75) Inventors: Ammon Cookson, Hillsboro, OR (US); Michael Ian Lieberman, Portland, OR (US)

Correspondence Address: MCANDREWS HELD & MALLOY, LTD, 500 WEST MADISON STREET, SUITE 3400, CHICAGO, IL, 60661, US

(73) Assignee: GENERAL ELECTRIC COMPANY, Schenectady, NY (US)

(21) Appl. No.: 11/774,111

(22) Filed: Jul. 6, 2007

(51) Int. Cl. G06Q 50/00; G06F 17/30; G06F 17/40

(52) U.S. Cl. 705/3

(57) ABSTRACT

Certain embodiments of the present invention provide systems and methods for organizing and querying patient data by a clinical information system via a clinical analysis integration service. Certain embodiments provide an electronic patient data system for exchanging electronic patient data between a data repository and a clinical system. The electronic patient data system includes an electronic data repository configured to aggregate and store patient-related data. The electronic data repository is accessible to and searchable by a plurality of clinical systems via a clinical analysis integration service. The system also includes a clinical analysis integration service providing data from the electronic data repository to one or more clinical systems in response to a query from a clinical system. In certain embodiments, one or more clinical systems may provide feedback to the electronic data repository and engage in an iterative dialog.

### BACKGROUND OF THE INVENTION

The present invention generally relates to clinical analysis information services (CAIS). More particular, the present invention relates to systems and methods facilitating interactive dialogue between clinical information systems via a CAIS.

Healthcare facilities, such as hospitals, clinics, doctor's offices and other inpatient or outpatient facilities typically utilize computer systems to manage various departments or units within the facility. Data about each patient is collected by a variety of computer systems. For example, a patient may be admitted to the hospital for a Transthoracic Echo (TTE). Information about the patient (e.g., demographics and insurance) could be obtained by the hospital information system (HIS) and stored on a patient record. This information could then be passed to the cardiology department system (commonly known as the cardio vascular information system, or CVIS). Typically the CVIS is a product of one company, while the HIS is the product of another company. As a result, the database between the two may be different. Further, information systems may capture/retain and send different levels of granularity in the data. Once the patient information has been received by the CVIS, the patient may be scheduled for a TTE in the echo lab. Next, the TTE is performed by the sonographer. Images and measurements are taken and sent to the CVIS server. The reading physician (e.g., an echocardiographer) sits down at a review station and pulls the patient's TTE study. The echocardiographer then begins to review the images and measurements and creates a complete medical report on the study. When the echocardiographer completes the medical report, the report is sent to the CVIS server where it is stored and associated with the patient through patient identification data. This completed medical report is an example of the kind of report that could be sent to a data repository for public data mining. Medication instructions, such as documentation and/or prescription, and treatments orders may also be generated electronically and saved in a data repository.

Data warehousing methods have been used to aggregate, clean, stage, report and analyze patient information derived from medical claims billing and electronic medical records (EMR). Patient data may be extracted from multiple EMR databases located at patient care provider (PCP) sites in geographically dispersed locations, then transported and stored in a centrally located data warehouse. The central data warehouse may be a source of information for population-based profile reports of physician productivity, preventative care, disease-management statistics and research on clinical outcomes. The central data warehouse may also be used to benchmark performance across multiple providers of care. Patient data is sensitive and confidential, and therefore, specific identifying information must be removed prior to transporting it from a PCP site to a central data warehouse. This removal of identifying information must be performed per the federal Health Insurance Portability and Accountability Act (HIPAA) regulations. Any data that is contained in a public database must not publicly reveal the identity of the individual patients whose medical information is contained in the database. Because of this requirement, any information contained on a medical report or record that could aid in tracing back to a particular individual must be removed from the report or record prior to adding the data to a data warehouse for public data mining.

### BRIEF SUMMARY OF THE INVENTION

Certain embodiments of the present invention provide systems and methods for facilitating interactive dialogued between clinical information systems via a clinical analysis integration service.

Certain embodiments provide a method for sharing patient data and related information in a clinical environment. The method includes organizing data in an electronic data repository for storage and retrieval by one or more external clinical systems. The method also includes receiving a query from a clinical system for data in the electronic data repository and processing the query, the query received via a clinical analysis integration service. Additionally, the method includes retrieving data from the electronic data repository based on the query. Further, the method includes outputting the data to the clinical system via the clinical analysis integration service. The clinical analysis integration service facilitates an iterative exchange of information between the electronic data repository and one or more clinical systems.

Certain embodiments provide an electronic patient data system for exchanging electronic patient data between a data repository and a clinical system. The electronic patient data system includes an electronic data repository configured to aggregate and store patient-related data. The electronic data repository is accessible to and searchable by a plurality of clinical systems via a clinical analysis integration service. The system also includes a clinical analysis integration service providing data from the electronic data repository to one or more clinical systems in response to a query from a clinical system. The clinical analysis integration service also provides feedback from the clinical system to the electronic data repository.

Certain embodiments provide a computer readable medium having a set of instructions for execution by a processor. The set of instructions includes an electronic data repository configured to aggregate and store patient-related data. The electronic data repository is accessible to and searchable by a plurality of clinical systems via a clinical analysis integration service. The set of instructions also includes a clinical analysis integration service providing data from the electronic data repository to one or more clinical systems in response to a query from a clinical system.

### BRIEF DESCRIPTION OF SEVERAL VIEWS OF THE DRAWINGS

FIG. 1 is an exemplary system for acquiring, storing, and transmitting electronic patient data in accordance with an embodiment of the present invention.

FIG. 2 is a block diagram of an exemplary data warehouse architecture in accordance with an embodiment of the present invention.

FIG. 3 illustrates a system for storage, retrieval, and reporting of patient data in accordance with an embodiment of the present invention.

FIG. 4 illustrates a clinical analysis integration system in accordance with an embodiment of the present invention.

FIG. 5 illustrates a flow diagram for a method for providing patient data storage and retrieval services in accordance with an embodiment of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

In certain embodiments of an electronic patient data system, data may be entered, stored, retrieved and used to generate reports, for example. Clinical reporting and analysis systems provide a visual end-user report to one or more users based on electronic patient and other clinical data. However, electronic medical data may also be used to drive related electronic processes and facilitate other clinical workflow.

Certain embodiments use electronic medical record data to enable external systems to establish rich data driven (e.g., extensible markup language or XML) dialogues/inquires related to the clinical analysis and reporting knowledge contained within an electronic medical record data warehouse. Electronic patient data content/analysis may incorporate a broader set of analysis and summaries pertaining to clinical data, patient/care management quality, and national standard measures, for example.

An electronic medical data warehouse, such as a CDS Data Warehouse, performs extensive data classification, transformation, summarization pertaining to various clinical domains (e.g., chronic disease management and/or quality outcomes based on national standards). Traditionally, user interface based reports have been the primary consumer of this end analysis/output. Certain embodiments provide XML based messaging/conversation patterns to support system-to-system dialogues/inquiries related to the subject matter of the electronic medical data, for example.

Certain embodiments facilitate a dialogue between clinical systems via a clinical analysis integration service (CAIS). In addition to one- or two-way queries involving a request and a response, a CAIS can facilitate rich, iterative dialogues between systems. CAIS may help provide advanced analytics/insights based on data stored in a particular system. CAIS may facilitate a series of multiple queries back-and-forth between clinical systems. Dialogue may include organizing, summarizing, iteratively querying and developing clinical insights, for example. Such an exchange of information and analysis over time helps enable richer dialogues to occur.

In certain embodiments, a CAIS may find patterns in retrieved data. Data may include patient data, related data, measures, insights regarding data, etc. Algorithms may be used to determine that, based on certain characteristics (e.g., matching certain profiles), a population has a strong possibility of developing diabetes, for example. Give the possibility, some preventative action may exist to help this population. In certain embodiments, patient and/or diagnosis information may be combined with financial data to determine how a healthcare practitioner can generate revenue while helping patients get better. An iterative dialogue or interaction between a clinical data warehouse and a CAIS, including a clinical data service (CDS), for example, can help facilitate this analysis.

Further, clinical systems, such as TTE, CVIS, HIS, etc., may augment their individual workflows by leveraging patient insights received from CDS/CAIS. For example, in a given workflow, information may exist that may augment or be helpful in some other workflow. As actions take place in the receiving system based on information from CAIS, the additional information becomes part of a patient health record, which goes back into the system and helps make system operation and interaction more intelligent. For example, a data warehouse may include standards identifying diabetic candidates for foot examination. A clinical information system may use the standards in combination with information regarding a diabetic patient population for that facility to determine who has and has not had a foot examination. Patients who have not yet had a foot examination may then be automatically scheduled or otherwise prompted for an exam, for example.

As another example, a healthcare information system may query a data warehouse via CAIS to determine if any of a certain patient list meet conditions for coronary artery disease. If the CAIS/CDS responds with a list of affected patients, the HIS requests interventions or actions recommended for such a condition. The CAIS/CDS responds with a set of recommended actions. The HIS may then use those actions in a patient treatment and/or scheduling workflow. As actions are completed, this information could again be pushed up to the CAIS/CDS for further analysis, feedback, etc.

An exemplary embodiment of the present invention is a secure process for sending de-identified patient information from a patient care provider (PCP) site (such as an ambulatory or outpatient PCP, an inpatient PCP system, a HIS containing patient information, etc.) to a data warehouse system where the patient data may be analyzed and compared with a wider range of patient data. The terms “de-identified patient information” and “de-identified patient data” as used in this document refer to both fully de-identified data as defined by HIPAA and limited data set data as defined by HIPAA. A limited data set is protected health information for research, public health and health care operations that excludes direct identifiers (e.g., name; postal address other than city, state and zip code; social security number; medical records numbers) but in which other identifying information may remain (e.g., dates of examination; documentation; diagnosis; prescription; lab test results). This is contrasted with fully de-identified data as defined by HIPAA, where all data that may be used to trace back to an individual patient is removed from the record. Information obtained through the data warehouse that pertains to individual patients is transmitted back to the originating PCP site, via a cohort report. Cohort reports are generated by queries that are executed against the data warehouse system to identify patient cohort groups. The individual patients included in a cohort report are then re-identified at the PCP site so that the PCPs may consider the information when deciding on treatment options for the individual patients.

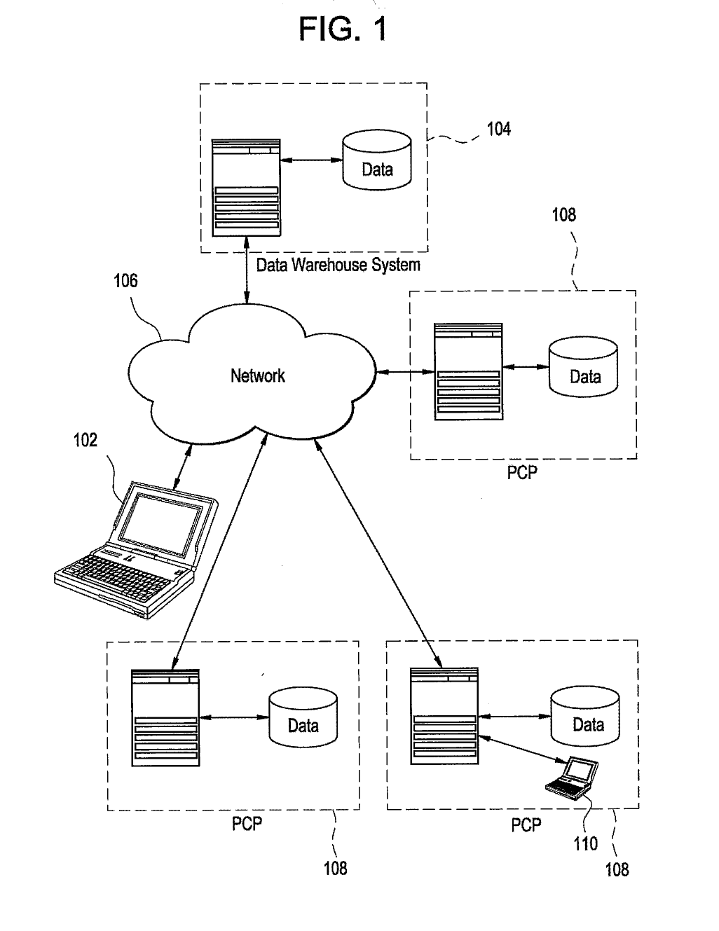

FIG. 1 is an exemplary system for acquiring, storing and transmitting electronic patient data. PCP systems 108 located at various PCP sites are connected to a network 106. The PCP systems 108 send patient medical data to a data warehouse located on a data warehouse system 104. The PCP systems 108 typically include application software to perform data extraction along with one or more storage device for storing the electronic medical records (EMRs) associated with patients treated at the PCP site. In addition, the PCP systems 108 may include PCP user systems 110 to access the EMR data, to initiate the data extraction and to enter a password string to be used for encrypting a patient identifier. The PCP user systems 110 may be directly attached to the PCP system 108 or they may access the PCP system 108 via the network 106. Each PCP user system 110 may be implemented using a general-purpose computer executing a computer program for carrying out the processes described herein. The PCP user systems 110 may be personal computers or host attached terminals. If the PCP user systems 110 are personal computers, the processing described herein may be shared by a PCP user system 110 and a PCP system 108 by providing an applet to the PCP user system 110. The storage device located at the PCP system 108 may be implemented using a variety of devices for storing electronic information such as a file transfer protocol (FTP) server. It is understood that the storage device may be implemented using memory contained in the PCP system 108 or it may be a separate physical device. The storage device contains a variety of information including an EMR database.

In addition, the system of FIG. 1 includes one or more data warehouse user systems 102 through which an end-user may make a request to an application program on the data warehouse system 104 to access particular records stored in the data warehouse (e.g., to create a cohort report). In an exemplary embodiment of the present invention, end-users may include PCP staff members, pharmaceutical or other company research team members and personnel from companies that make medical or other products. The data warehouse user systems 102 may be directly connected to the data warehouse system 104 or they may be coupled to the data warehouse system 104 via the network 106. Each data warehouse user system 102 may be implemented using a general-purpose computer executing a computer program for carrying out the processes described herein. The data warehouse user systems 102 may be personal computers, host attached terminals, software and/or other processors. If the data warehouse user systems 102 are personal computers, the processing described herein may be shared by a data warehouse user system 102 and the data warehouse system 104 by providing an applet to the data warehouse user system 102.

The network 106 may be any type of known network including a local area network (LAN), a wide area network (WAN), an intranet, or a global network (e.g., Internet). A data warehouse user system 102 may be coupled to the data warehouse system 104 through multiple networks (e.g., intranet and Internet) so that not all data warehouse user systems 102 are required to be coupled to the data warehouse system 104 through the same network. Similarly, a PCP system 108 may be coupled to the data mining host system 104 through multiple networks (e.g., intranet and Internet) so that not all PCP systems 108 are required to be coupled to the data warehouse system 104 through the same network. One or more of the data warehouse user systems 102, the PCP systems 108 and the data warehouse system 104 may be connected to the network 106 in a wireless fashion and the network 106 may be a wireless network. In an exemplary embodiment, the network 106 is the Internet and each data warehouse user system 102 executes a user interface application to directly connect to the data warehouse system 104. In another embodiment, a data warehouse user system 102 may execute a web browser to contact the data warehouse system 104 through the network 106. Alternatively, a data warehouse user system 102 may be implemented using a device programmed primarily for accessing the network 106 such as WebTV.

The data warehouse system 104 may be implemented using a server operating in response to a computer program stored in a storage medium accessible by the server. The data warehouse system 104 may operate as a network server (often referred to as a web server) to communicate with the data warehouse user systems 102 and the PCP systems 108. The data warehouse system 104 handles sending and receiving information to and from data warehouse user systems 102 and PCP systems 108 and can perform associated tasks. The data warehouse system 104 may also include a firewall to prevent unauthorized access to the data warehouse system 104 and enforce any limitations on authorized access. For instance, an administrator may have access to the entire system and have authority to modify portions of the system and a PCP staff member may only have access to view a subset of the data warehouse records for particular patients. In an exemplary embodiment, the administrator has the ability to add new users, delete users and edit user privileges. The firewall may be implemented using conventional hardware and/or software as is known in the art.

The data warehouse system 104 also operates as an application server. The data warehouse system 104 executes one or more application programs to provide access to the data repository located on the data warehouse system, as well as application programs to import patient data into a staging area and then into the data warehouse. In addition, the data warehouse system 104 may also execute one or more applications to create patient cohort reports and to send the patient cohort reports to the PCP systems 108. Processing may be shared by the data warehouse user system 102 and the data warehouse system 104 by providing an application (e.g., java applet) to the data warehouse user system 102. Alternatively, the data warehouse user system 102 can include a stand-alone software application for performing a portion of the processing described herein. Similarly, processing may be shared by the PCP system 102 and the data warehouse system 104 by providing an application to the PCP system 102 and alternatively, the PCP system 102 can include a stand-alone software application for performing a portion of the processing described herein. It is understood that separate servers may be used to implement the network server functions and the application server functions. Alternatively, the network server, firewall and the application server can be implemented by a single server executing computer programs to perform the requisite functions.

The storage device located at the data warehouse system 104 may be implemented using a variety of devices for storing electronic information such as a file transfer protocol (FTP) server. It is understood that the storage device may be implemented using memory contained in the data warehouse system 104 or it may be a separate physical device. The storage device contains a variety of information including a data warehouse containing patient medical data from one or more PCPs. The data warehouse system 104 may also operate as a database server and coordinate access to application data including data stored on the storage device. The data warehouse may be physically stored as a single database with access restricted based on user characteristics or it can be physically stored in a variety of databases including portions of the database on the data warehouse user systems 102 or the data warehouse system 104. In an exemplary embodiment, the data repository is implemented using a relational database system and the database system provides different views of the data to different end-users based on end-user characteristics.

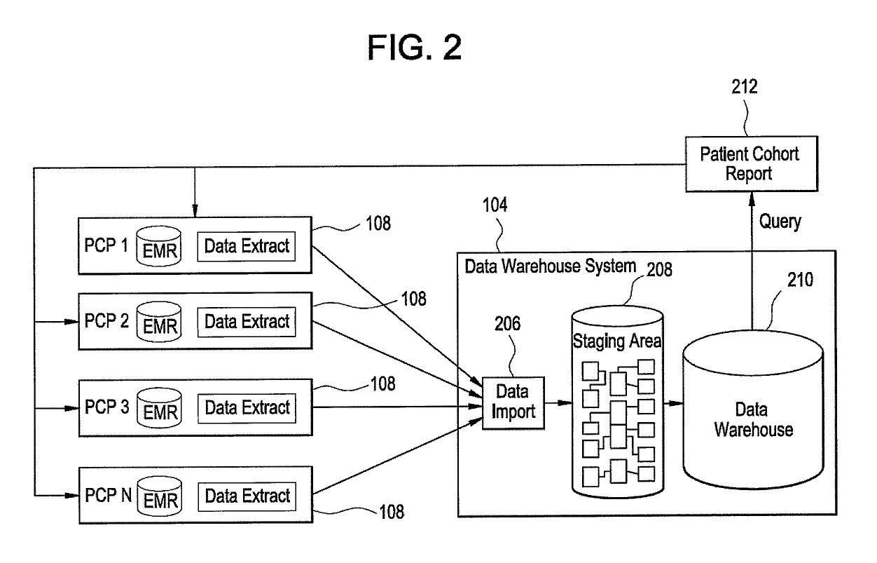

FIG. 2 is a block diagram of an exemplary data warehouse architecture. Patient data is extracted from EMR databases located in the PCP systems 108. In an exemplary embodiment of the present invention, an EMR database record includes data such as: patient name and address, medications, allergies, observations, diagnoses, and health insurance information. The PCP systems 108 include application software for extracting patient data from the EMR database. The data is then de-identified and transported (e.g., via Hypertext Transfer Protocol (HTTPS)) over the network 106 to the data warehouse system 104. The data warehouse system 104 includes application software to perform a data import function 206. The data import function 206 aggregates and cleanses de-identified patient data from multiple sites and then stores the data into a staging area 208. Data received from multiple PCP systems 108 is normalized, checked for validity and completeness, and either corrected or flagged as defective. Data from multiple PCP systems 108 is then combined together into a relational database. Aggregation, cleaning and staging data in the described fashion allows the data to be queried meaningfully and efficiently, either as a single entity or specific to each individual PCP site 108. The de-identified patient data is then staged into a data warehouse 210 where it is available for querying.

Patient cohort reports 212 are generated by application software located on the data warehouse system 104 and returned to the PCP systems 108 for use by the primary care providers in treating individual patients. Patient cohort reports 212 may be automatically generated by executing a canned query on a periodic basis. PCP staff members, pharmaceutical or other company research team members and personnel from companies that make medical or other products may each run patient cohort reports 212. In addition, patient cohort reports 212 may be created by an end-user accessing a data warehouse user system 102 to create custom reports or to initiate the running of canned reports. Further, patient cohort reports 212 may be automatically generated in response to the application software, located on the data warehouse system 104, determining that particular combinations of data for a patient are stored in the data warehouse. An exemplary patient cohort report 212 includes all patients with a particular disease that were treated with a particular medication. Another exemplary patient cohort report 212 includes patients of a particular age and sex who have particular test results. For example, a patient cohort report 212 may list all women with heart disease who are taking a hormone replacement therapy drug. The patient cohort report 212 would list all the patients with records in the data warehouse 210 that fit this criteria along with a warning about the possible side-effects and the likelihood of the side-effects occurring. In an exemplary embodiment, each PCP site receives the entire report, in another embodiment, each PCP site receives the report only for patients that are being treated at the PCP site.

In an exemplary embodiment, the ability to create patient cohort reports 212 based on querying longitudinal patient data is supported by the ability to connect all records relating to a single patient in the data warehouse 210. This requires a unique identifier to be associated with each patient record that is transmitted to the data warehouse 210. The unique identifier must not be traceable back to an individual patient by end-users accessing the data warehouse 210. However, individual PCPs may want to retain the ability to re-identify a patient based on the unique identifier so that the medical personnel located at the PCP site can follow through with the patient in response to information included in the patient cohort reports 212.

In an exemplary embodiment, an EMR database includes the following patient identifying demographic data: names; geographic identifiers, including address; dates directly related to an individual, including birth date, admission date, discharge date and date of death; telephone and fax numbers; electronic mail addresses; social security number; medical record number; health plan beneficiary; account numbers; certificate or license numbers; vehicle identifiers and serial numbers including license plate numbers; device identifiers and serial numbers, web Universal Resource Locators (URLs) and internet protocol (IP) address numbers; biometric identifiers, including finger and voice prints; full face photographic images and comparable images; other unique identifying numbers, characteristics and codes assigned by the PCP or by the EMR system for administrative purposes, including a patient identifier (PID). The EMR database also includes information about: the patient diagnosis or problem; medications taken or prescribed; observations, diagnostic laboratory tests and vital signs; subjective and objective findings, assessments, orders, plans, and notes documented by healthcare providers. The EMR database also includes audit information that records the date, time, and identity of persons who have created, read, updated, or deleted information from the patient record. The EMR database record for each patient also contains a numeric key known as the PID which may be used to uniquely identify an individual patient. The PID is encoded as part of the de-identification process to create an encoded patient identifier (EPID). The EPID may be sent, along with the de-identified patient data, to the data warehouse system 104.

A data extraction process may be performed by application software located on the PCP system 108, for example, and may be executed in the background on a periodic basis (e.g., at 2 a.m. every night, at 2 a.m. every Saturday). In this manner, the extraction process will be less likely to interfere with existing software located on the PCP system 108. The extraction process may also be initiated by a remote system (e.g., the data warehouse system 104) and may include full or incremental back-up schemes. In an exemplary embodiment, the following identifiers are removed or transformed in order to create de-identified data that would be classified under the HIPAA definition as fully de-identified data: name, geographic subdivisions smaller than a state including street address, city, county, precinct, zip code (down to the last three digits), dates directly related to an individual (e.g., birth date), phone and fax numbers, electronic mail addresses, health plan number, account number, certificate/license number, device identifier and serial numbers, unified resource locator (URL), internet protocol (IP) address, biometric identifiers, full face photograph, and other unique identifying numbers, characteristics or codes.

In an alternate exemplary embodiment of the present invention, the following identifiers are removed or transformed in order to create de-identified that that would be classified under the HIPAA definition as limited data set information: direct identifiers such as name, postal address (other than city, state and zip code), social security number and medical records numbers. In the limited data set information implementation of the present invention some identifying information may remain such as dates of examination, documentation, diagnosis, prescription and lab test results.

In certain embodiments, ambulatory PCPs may send patient data into a data warehouse containing patient data from other ambulatory PCPs. In this manner, patient data may be analyzed and compared to a larger population of patients. The de-identified patient data includes an EPID that may be useful in creating longitudinal reports that analyze more than one record for a particular patient. The effects of certain drugs and treatments on patient cohort groups can be analyzed and may lead to improvements in the use or composition of the drugs and treatments. In addition, an embodiment of the present invention allows for the PCP to receive cohort reports 212 based on data contained in the data warehouse. These patient cohort reports 212 include an EPID for each patient. The EPID may be decoded at the PCP site that created the EPID and used to identify a particular patient. In this manner a PCP, by considering the information contained in the cohort report, may be able to provide improved treatment to the patient. This ability to provide useful information back to a patient level may also lead more PCPs to participate in sending patient data to a data warehouse. Having more data in the data warehouse may provide more useful information to third parties such as pharmaceutical companies, medical device companies and physicians about the effects and risks of particular treatments, while minimizing the risk of disclosing patient-identifying information to third parties. This may lead to improvements in preventative care as well as other types of medical care.

In certain embodiments, EMR updates are “pulled”, “pushed”, or otherwise communicated to a database, data warehouse and/or other data store on a periodic basis (e.g., nightly, weekly, etc.). In certain embodiments, changes made locally to re-identified patient records are de-identified and communicated to the EMR system and/or database for storage.

In certain embodiments, a user may search for one or more patient records within EMR by invoking a “find” dialog or search function. The user may search by the EPID, for example, and enter or select an EPID number to activate a search. The corresponding patient chart may be retrieved and displayed. Thus, a patient may be re-identified for an authorized healthcare provider who has been identified and verified. In certain embodiments, the user can be a person or a system. Searching may prompt and/or be taken in conjunction with automated exchange of information between clinical systems and data warehouses, for example.

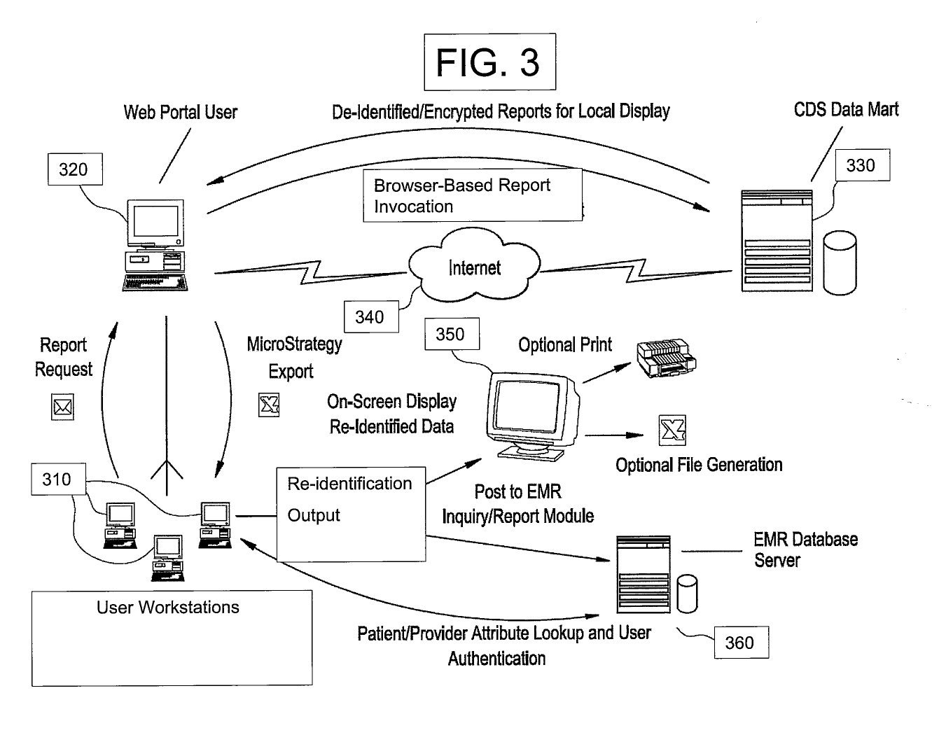

FIG. 3 illustrates a system 300 for storage, retrieval and reporting of patient data in accordance with an embodiment of the present invention. The system 300 includes one or more user workstations 310, a web portal 320, a data store 330 and a data link 340. The system 300 may also include a display 350 and/or a data server 360, for example. The system 300 may include one or more software processes, computers and/or other processors instead of and/or in addition to the workstation(s) 310, for example. The system 300 may include one or more web services instead of and/or in addition to the web portal 320, for example.

The components of the system 300 may be implemented alone or in combination in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device. Certain components may be integrated in various forms and/or may be provided as software and/or other functionality on a computing device, such as a computer. Certain embodiments may omit one or more of the components of the system 300 to execute storage, retrieval and/or reporting, as well as the re-identification and/or de-identification functions and communication of data between a local user and a data store.

In operation, the workstation 310 or other processor may request data via the web portal 320 or other web service. For example, a user at the workstation 310 requests patient-related data via a web browser that accesses the web portal 320. The web portal 320 communicates with the data store 330 via a data link 340. For example, the web portal 320 requests the data from the data store 330, such as from an EMR data mart, via a network, such as the Internet or a private network. The data store 330 returns the requested data to the workstation 310 via the web portal 320. The data may include non-HIPAA-protected data, de-identified/encrypted patient data, re-identified patient data, and/or other data, for example.

The user workstation 310 may communicate with the display 350 to display data transmitted from the data store 330. Data may also be printed and/or used to generate a file, for example. The workstation 310 may also communicate with the data server 360 to transmit the data and/or other update, for example.

In certain embodiments, a de-identified patient report is transmitted to the workstation 310 from the data store 330 via the web portal 320 in response to a request from the workstation 310. The workstation 310 performs a re-identification of the de-identified patient data locally at the workstation 310. The re-identification may be performed via lookup of an EPID to determine a corresponding PID or other similar technique, for example. The re-identification functionality may be integrated into a document viewing/editing program, such as Microsoft Excel, Microsoft Word, and/or other software, for example. The re-identification function may access data in an external source, such as the data store 330 and/or the data server 360, to match the EPID to the PID. In certain embodiments, the EPID is replaced with the PID and/or other patient identifying information (e.g., patient name) in a document at the workstation 310.

In certain embodiments, the workstation 310 may first authenticate a privilege or right of access via the server 360, for example, before the patient data is re-identified. The workstation 310 may also lookup patient and/or provider attributes via the server 360 and/or data store 330, for example.

Many systems can benefit from richer analysis of patient data. However, infrastructure, processing, and analysis complexities often make it impractical to incorporate this capability at the individual system level. These systems can utilize clinical analysis data to augment their workflows, etc., without dependency on creating/replicating the transformation, classification, and summarization services of a data warehouse.

For example, a patient is scheduled for an acute care visit, and, at the same time, is classified according to a national standard as an “Active Diabetic.” Diabetic patients should have an annual foot exam, but this patient has not had his/her annual foot exam. In certain embodiments, a clinical scheduling system may query a data warehouse if patient X needs or is recommended to have any chronic disease management events, such as a diabetic foot exam. The data warehouse responds with a message to the clinical scheduling system indicating that patient X needs a foot exam. This message may be integrated within a local messaging/alerting system to assist a clinical care team in taking advantage of the patient's appointment to address both the acute and chronic needs during the scheduled visit.

In certain embodiments, reports generated by a clinical reporting system enable end-users to get answers to specific questions. Those answers in turn may influence end user interactions with other clinical systems if the end users review the report. Using clinical analysis integration services (CAIS), systems can leverage the domain content represented by a particular report and integrate that information into the appropriate, relevant receiving system's context.

For example, a system to system dialogue may include, for a particular doctor's schedule, a display or generation of data showing which patients have preventative care/chronic disease actions that should be taken. As another example, a local business intelligence data warehouse seeks to incorporate quality data at the patient level but does not want to replicate logic, transformation, and load work to summarize, classify and produce national standards based measures. The local business intelligence data warehouse may subscribe to a patient analysis for a particular domain (e.g., an organization, clinic, doctor, patient(s), etc.) and receive a regular data feed to import into its data warehouse.

Further, a pharmaceutical company includes a safety and surveillance system. The company is interested in occurrence of patient/clinical events related to a particular patient population. Using an electronic data service, the company system can send events that the safety system is interested in to a clinical data system in a format, such as an XML format, and the clinical data system can send those event(s) back as messages to the pharmaceutical safety and surveillance system when the event(s) occur.

In addition to visual reporting, with CAIS, a variety of customers/recipients/systems can leverage stored electronic clinical data and analysis. In certain embodiments, data may be provided between systems via a web service, for example. In certain embodiments, data analysis may be replicated for each local system that may benefit from the clinical data. In certain embodiments, patient data may be integrated into a local business intelligence data warehouse.

In certain embodiments, CAIS may be provided as a part or component of a service offering to customers. For example, as described above, a pharmaceutical customer may be for an alerting service for a particular patient population. In certain embodiments, CAS may be a component of a product offered to customers. For example, a local business intelligence data warehouse may be offered that includes an interface to an electronic medical data warehouse using CAIS. A CAIS may be provided as a Web service, for example.

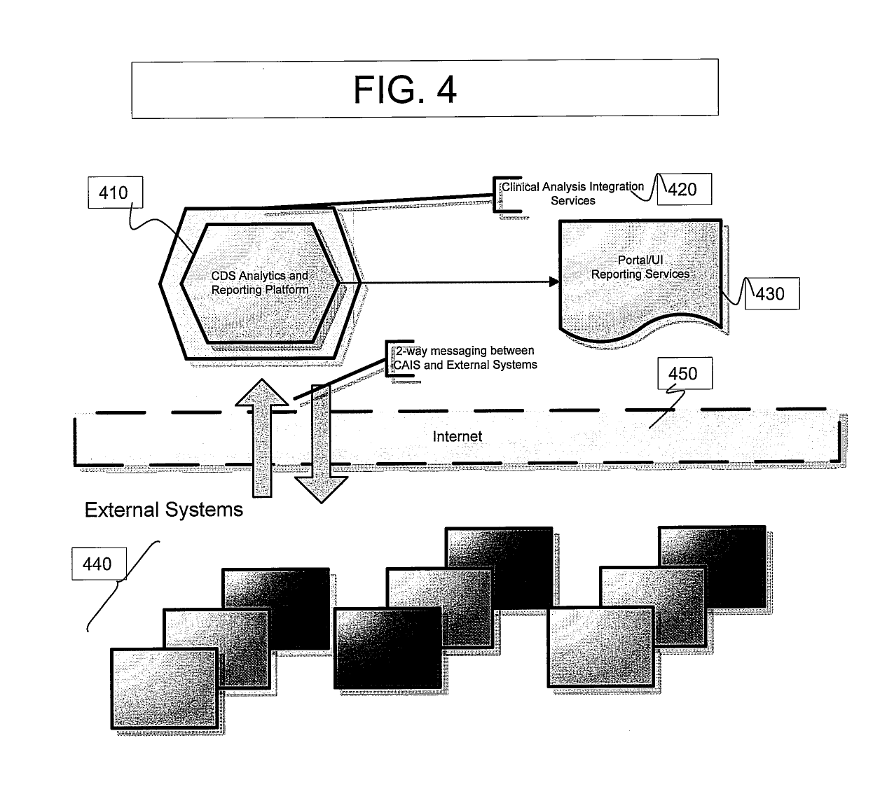

FIG. 4 illustrates a clinical analysis integration system 400 in accordance with an embodiment of the present invention. The system 400 includes an analytics and reporting platform 410, clinical analysis integration services (CAIS) 420, portal/user interface reporting services 430, one or more external systems 440, and a network 450. The components of the system 400 may be implemented individually or in various combinations of hardware, software and/or firmware, for example.

The network 450 may include one or more networks such as the Internet, a private network, a dedicated network, a local area network, a wide area network, etc. Information sharing may be facilitated by the system 400 using an interface standard, such as the standards approved by the Health Information Technology Standards Panel (HITSP) and accepted by the US Department of Health and Human Services (HHS), Health Level Seven (HL7) and/or Digital Imaging and Communications in Medicine (DICOM) communication interface and file format standards. CAIS 420 may provide data from a data repository to one or more external systems 440 via the analytics and reporting platform 410 and the network 450. Two-way messaging over the network 450 allows information to be shared between the CAIS 420 and external system(s) 440.

Data from one or more data repositories may also and/or alternatively be provided to one or more viewers or portals 430 via a server or application, such as the platform 410. In certain embodiments, the portal 430 may be a Web-based portal provided data via a Web server platform 410.

In certain embodiments, the portal 430 may be used to facilitate access to information, patient care and/or practice management, for example. Information and/or functionality available via the portal 430 may include one or more of order entry, laboratory test results review system, patient information, clinical decision support, medication management, scheduling, electronic mail and/or messaging, medical resources, etc.

In certain embodiments, the portal 430 serves as a central interface to access information and applications, for example. Data may be viewed through the portal or viewer 430, for example. Additionally, data may be manipulated and propagated using the portal 430, for example. Data may be generated, modified, stored and/or used and then communicated to another application or system to be modified, stored and/or used, for example, via the portal 430.

In certain embodiments, the portal 430 may be accessible locally (e.g., in an office) and/or remotely (e.g., via the Internet and/or other private network or connection), for example. The portal 430 may be configured to help or guide a user in accessing data and/or functions to facilitate patient care and practice management, for example. In certain embodiments, the portal 430 may be configured according to certain rules, preferences and/or functions, for example. For example, a user may customize the portal 430 according to particular desires, preferences and/or requirements.

In certain embodiments, a Cross Document Sharing (XDS) profile and/or protocol (e.g., an Integrating the Healthcare Enterprise Cross-Enterprise Sharing of Medical Summaries Integration Profile (IHE XDS-MS) protocol) may be used to define a coupling or connection between one or more entities, such as a data repository, portal 430, analytics and reporting platform 410, and/or external system 440, for patient document sharing. For example, XDS may be used to form a query identifying sources with information about a particular patient and/or other criteria, determining an identifier used to associate clinical data related to the patient and/or other criteria and request patient information from the appropriate source and/or repository, for example.

In certain embodiments, patient privacy consent may provide a profile for access control to data and/or systems, for example. Patient consent is obtained from a patient and establishes rules for sharing and using patient data. Patient privacy consent may combine with authentication, for example, to help ensure reliability and security in the system 400.

In certain embodiments, data source(s)/repository(ies) may include EMR, radiology, laboratory and/or other clinical data sources, for example. Data query source(s) may include clinicians, administrators, insurers, pharmacies, prescription benefit managers, and/or other services, for example.

The CAIS 420 assists the analysis and reporting platform 410 in providing data to an external system 440 via the network 450 in response to a query from the external system 440. Thus, data may be shared among information sources and systems to drive workflows and other tasks in addition to being output in reports, used for trending analysis, and stored, for example. In certain embodiments, data may be shared between systems without the use of a separate user interface based on user initiation. For example, raw patient data may be taken from a data warehouse and transformed by another system to produce high-level metrics around one or more specific diseases according to industry standards. Data may be made accessible for any of a variety of authorized applications wishing to take advantage of the information.

In certain embodiments, raw patient data is obtained, cleansed and stored in a data warehouse to create a data mart. Different high level data models may be created for different disease areas, for example, in the data mart. Healthcare practitioners may then, with little training, perform their own ad hoc queries in different areas to retrieve information from the data mart. Data models are created to optimize ad hoc queries around different disease areas, for example. Users may take advantage of common forms without having a detailed knowledge of the underlying infrastructure or data structure. For example, many fields may be combined in one query that simply asks the user if a patient is smoking or not. Healthcare informatics inquiries may be improved through the use of data models and a data mart as well. In certain embodiments, a data mart may be created in a portal context for access via the portal 430, for example. In certain embodiments, a plurality of specialized data marts may be created for different clinical areas, for example.

Thus, CAIS 420 and analysis/reporting platform 410 allow system(s) 440 to benefit from patient data analysis without having the infrastructure, processing, and analysis capabilities incorporated at the individual system level. A clinical application may query the data mart and/or EMR system via the CAIS 420 and platform 410 to retrieve related information for combination in a patient diagnosis and treatment workflow, patient analysis, etc., for example.

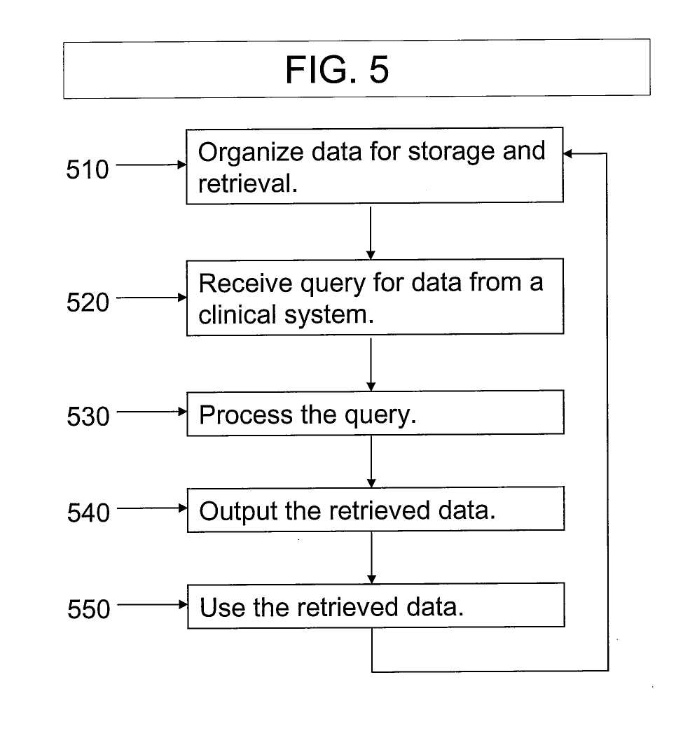

FIG. 5 illustrates a flow diagram for a method 500 for providing patient data storage and retrieval services in accordance with an embodiment of the present invention. At step 510, data is organized for storage and retrieval. For example, data may be formatted, normalized, scrubbed, etc. for storage in a shared data repository. Data may be organized in a data warehouse and/or one or more data marts, for example. At step 520, a query for data is sent from a clinical system. For example, a patient monitoring system sends a query to a data mart of patient data for a particular disease via a CAIS message. The query may request a list of patients with a particular disease for whom a particular patient event has occurred.

At step 530, the query is processed. For example, a pre-fetching of data and/or other query function may be triggered to locate and retrieve requested data from one or more repositories. At step 540, the retrieved data is output. For example, retrieved data may be transmitted to a local EMR, output to an ASP-provided office system, provided as input to a patient management or scheduling system, etc. At step 550, the retrieved data is utilized by the requesting system. For example, data regarding patients for whom an upcoming examination is recommended for a particular disorder may be used by a scheduling program to incorporate examination scheduling into a calendar for relevant patients.

One or more of the steps of the method 500 may be implemented alone or in combination in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device.

Certain embodiments of the present invention may omit one or more of these steps and/or perform the steps in a different order than the order listed. For example, some steps may not be performed in certain embodiments of the present invention. As a further example, certain steps may be performed in a different temporal order, including simultaneously, than listed above.

Thus, certain embodiments provide improved patient data sharing and analysis via clinical analysis integration services. Certain embodiments provide a technical effect of organizing, storing and retrieving patient data at an external system lacking its own resources for such organizing, storing and searchability of patient data. Certain embodiments provide patient data availability through one or more data marts via queries from one or more external healthcare information systems, for example.

In certain embodiments, broader analysis of patient information may be allowed while at the same time respecting patient privacy. Communities of health care providers may benchmark, and compare patient populations without compromising patient privacy. At the same time, a patient's provider may re-identify patients from within the patient populations at the local level that are hosted/presented by the encrypted site. Re-identification algorithms may be stored locally at the healthcare provider level, for example. This physical separation may limit a potential risk of other providers who are viewing de-identified data on a portal from viewing patient identifiable information.

Certain embodiments allow for patient information to be shared with interested parties without compromising patient privacy. In the broader healthcare space, there will be applications where researchers, government agencies, communities of practice, may want to study patient populations but are, as of now, restricted because no good mechanism exists to work with source data providers in de-identifying and re-identifying patients. Certain embodiments facilitate such interaction. For example, decrypted information may be re-identified and then consumed by or imported into a patient's provider system within Microsoft™ Excel, Centricity Physician Office EMR application and/or other application. Other entities, such as researchers and agencies, may view and/or manipulate the encrypted or de-identified data with reduced risk of compromising patient privacy.

Several embodiments are described above with reference to drawings. These drawings illustrate certain details of specific embodiments that implement the systems and methods and programs of the present invention. However, describing the invention with drawings should not be construed as imposing on the invention any limitations associated with features shown in the drawings. The present invention contemplates methods, systems and program products on any machine-readable media for accomplishing its operations. As noted above, the embodiments of the present invention may be implemented using an existing computer processor, or by a special purpose computer processor incorporated for this or another purpose or by a hardwired system.

As noted above, embodiments within the scope of the present invention include program products comprising machine-readable media for carrying or having machine-executable instructions or data structures stored thereon. Such machine-readable media can be any available media that can be accessed by a general purpose or special purpose computer or other machine with a processor. By way of example, such machine-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such a connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

Embodiments of the invention are described in the general context of method steps which may be implemented in one embodiment by a program product including machine-executable instructions, such as program code, for example in the form of program modules executed by machines in networked environments. Generally, program modules include routines, programs, objects, components, data structures, etc., that perform particular tasks or implement particular abstract data types. Machine-executable instructions, associated data structures, and program modules represent examples of program code for executing steps of the methods disclosed herein. The particular sequence of such executable instructions or associated data structures represents examples of corresponding acts for implementing the functions described in such steps.

Embodiments of the present invention may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of the invention might include a general purpose computing device in the form of a computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD ROM or other optical media. The drives and their associated machine-readable media provide nonvolatile storage of machine-executable instructions, data structures, program modules and other data for the computer.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another.

1. A method for sharing patient data in a clinical environment, said method comprising:
organizing data in an electronic data repository for storage and retrieval by one or more external clinical systems;
establishing a dialog between a clinical system and the electronic data repository via a clinical analysis integration service, the dialog including receiving a query from the clinical system for data in the electronic data repository, the query received via the clinical analysis integration service;
processing the query;
retrieving data from the electronic data repository based on the query; and
outputting the data to the clinical system via the clinical analysis integration service.

2. The method of claim 1, further comprising outputting the data via a user interface portal.

3. The method of claim 1, further comprising using the data at the clinical system in combination with at least one of an application and additional data at the clinical system.

4. The method of claim 1, wherein the electronic data repository comprises at least one of a data warehouse and a data mart.

5. The method of claim 1, wherein said organizing step further comprises organizing data in the electronic data repository based on one or more data models.

6. The method of claim 5, wherein each of said one or more data models relates to a particular disease.

7. The method of claim 1, wherein the query includes at least one of a patient identifier reference and a patient demographic query.

8. The method of claim 1, wherein the data comprises national measurement analysis and wherein the method further comprises combining the national measurement analysis data from the electronic data repository with at least one of local patient data and clinical application at the clinical system.

9. The method of claim 1, wherein the clinical analysis integration service facilitates communication between the electronic data repository and the clinical system via extensible markup language based messaging.

10. The method of claim 1, further comprising iteratively querying the electronic data repository from the clinical system and providing information feedback from the clinical system to the electronic data repository.

11. An electronic patient data system for exchanging electronic patient data between a data repository and a clinical system, said electronic patient data system comprising:
an electronic data repository configured to aggregate and store patient-related data, said electronic data repository accessible to and searchable by a plurality of clinical systems via a clinical analysis integration service; and
a clinical analysis integration service providing data from the electronic data repository to one or more clinical systems in response to a query from a clinical system, said clinical analysis integration service facilitating an iterative exchange of information between the electronic data repository and one or more clinical systems.

12. The electronic patient data system of claim 11, further comprising a portal providing an authorized user access to said electronic data repository.

13. The electronic patient data system of claim 11, wherein said electronic data repository further comprises an analytics and reporting platform providing analysis based on data in said electronic data repository.

14. The electronic patient data system of claim 11, wherein said electronic data repository comprises at least one of a data warehouse and a data mart.

15. The electronic patient data system of claim 11, wherein data in said electronic data repository is organized based on one or more data models.

16. The electronic patient data system of claim 15, wherein each of said one or more data models relates to a particular disease.

17. The electronic patient data system of claim 11, wherein the query includes at least one of a patient identifier reference and a patient demographic query.

18. The electronic patient data system of claim 11, wherein the clinical system comprises at least one of a scheduling system and an information system.

19. The electronic patient data system of claim 11, wherein the data comprises national measurement analysis and wherein the national measurement analysis data from said electronic data repository is combined with at least one of local patient data and clinical application at the clinical system.

20. The electronic patient data system of claim 11, wherein said clinical analysis integration service facilitates communication between said electronic data repository and the clinical system via extensible markup language based messaging.

21. A computer readable medium having a set of instructions for execution by a processor, said set of instructions comprising:
an electronic data repository configured to aggregate and store patient-related data, said electronic data repository accessible to and searchable by a plurality of clinical systems via a clinical analysis integration service; and
a clinical analysis integration service providing data from the electronic data repository to one or more clinical systems in response to a query from a clinical system and providing feedback from the clinical system to the electronic data repository.
